(19) United States
(12) Patent Application Publication
(10) Pub. No.: US 2013/0014315 A1
(43) Pub. Date: Jan. 17, 2013

(54) HELMETS AND VEHICLES WITH PHOTOCHROMIC MATERIAL

(71) Applicants: Rogelio Valdez Diaz, West Hollywood, CA (US); Chanelle Valdez, West Hollywood, CA (US)

(72) Inventors: Rogelio Valdez Diaz, West Hollywood, CA (US); Chanelle Valdez, West Hollywood, CA (US)

(21) Appl. No.: 13/181,468

(22) Filed: Jul. 12, 2011

(51) Int. Cl. A42B 3/22; B60J 7/043; B60J 3/00; A63B 71/10; A42B 3/20

(52) U.S. Cl. 2/424; 2/10; 2/425; 296/97.1; 296/216.01

(57) ABSTRACT

Provided are helmets and vehicles with photochromic materials, such as visors for helmets and windows and windshields for vehicles.

### BACKGROUND SECTION OF THE INVENTION

Sunlight, including glare, interferes with vision in many different everyday activities. For example, in American football, safety and performance are critical issues on the field. Football players are exposed to repeated impacts of all kinds that put them at risk. Given the potential for a player's fingers to accidentally or intentionally make contact with another player's eyes, eye protection is very desirable. Football helmets have facemasks wherein the wearer's eyes are largely unprotected from contact with external objects. Moreover, a player's vision, and thus performance, can be adversely affected by the glare caused by the sun during day games or by bright lights during night/indoor games. Visors that fit into the helmet facemask feature a tinted or mirrored visor surface. However, existing visors have a disadvantage in that they darken the player's vision at all time, regardless of whether the player is being faced with glaring light. As a result, the player's vision and performance becomes impaired during normal-light or low-light situations. This problem also affects other sports where a helmet is required, including riding a motorcycle, baseball (the baseball catcher's helmet), and others.

This problem of glare and bright sun also affects occupants of vehicles, including boats, automobiles, air planes and helicopters. With automobile, one solution is to tint the windows, but this also causes the inside of the automobile to be dark even in the absence of light.

Thus, there is a need in the art for materials for helmets and vehicles that enhances, but does not impair, vision under varying light conditions.

### SUMMARY OF THE INVENTION

In one embodiment, the present invention provides a helmet for protecting head against impact comprising: a) a helmet shell with an open space for eyes to see through; b) a shatterproof photochromic visor that becomes darker in presence of UV light; wherein the visor is placed in the open space of the helmet shell so a user wearing the helmet sees through the visor. The visor can be constructed of shatterproof polycarbonate material. The visor can provide UVA and UVB protection. The visor surface can have a curvature that matches that of the helmet. The helmet can be for playing sports, such as an American football helmet that further comprises a facemask. The football helmet can have a face mask with one or more substantially horizontal structures cutting the facemask in an upper and a lower portion, with the upper portion covering the front of the eyes, wherein the visor covers at least the entire space in the upper portion. The helmet can be a baseball, softball or a cricket helmet that further comprises a facemask. The helmet can be a motorcycle helmet. The visor can be a prescription lens. The visor can be removably attached to the helmet. The visor can be about 4 inches to about 10 inches long at the maximum length and about 2 inches to about 6 inches wide at the maximum width.

In another embodiment, the present invention provides a vehicle for transportation by land, air, or water, comprising: a) a passenger compartment; and b) a photochromic material attached to the vehicle through which a passenger sees outside of the passenger compartment, wherein the photochromic material becomes darker in presence of UV light. The vehicle can be a motorcycle and the material can be placed in front of the watert to shield a driver from wind. The vehicle can be an automobile and at least a portion of one or more of the windshield, side windows, and back window made of the photochromic material. The vehicle can be an automobile and the two back windows on the side and the back window made of the photochromic material. The vehicle can be an automobile and only top portion of the front or back windshield made of photochromic material. The vehicle can be a boat and at least a portion of windshield or a window made of a photochromic material.

In another embodiment, the present invention provides an automobile comprising a passenger compartment with a sunroof, wherein the sunroof is made of a photochromic material.

### BRIEF DESCRIPTION OF THE FIGURES

FIG. 1 illustrates a photochromic football visor that in the absence of UV light is clear and lacks tinting.

FIG. 2 illustrates the visor of FIG. 1 in the presence of light, where the visor has become tinted.

FIG. 3 illustrated the visor of FIG. 2 attached to a football helmet shell on the inside of the facemask.

FIG. 4 illustrates a baseball catcher's helmet with a photochromic visor that in the absence of UV light is clear and lacks tinting.

FIG. 5 illustrates a baseball catcher's helmet with a photochromic visor that in the presence of UV has been activated and has a tint.

FIG. 6 illustrates a motorcycle helmet with a photochromic visor that in the absence of UV light is clear and lacks tinting.

FIG. 7 illustrates a motorcycle helmet with a photochromic visor that in the presence of UV has been activated and has a tint.

FIG. 8 illustrates an automobile with a windshield and front and back side windows made with photochromic material that in the absence of UV light is clear and lacks tinting.

FIG. 9 illustrates an automobile with a windshield and front and back side windows made with photochromic material that have been activated and have a tint.

FIG. 10 illustrates an automobile with a top portion of windshield made with photochromic material that has been activated and has a tint.

FIG. 11 illustrates a boat with a windshield made with photochromic material that in the absence of UV light is clear and lacks tinting.

FIG. 12 illustrates a boat with a windshield made with photochromic material that has been activated and has a tint.

FIG. 13 illustrates a motorcycle with a windshield made with photochromic material that in the absence of UV light is clear and lacks tinting.

FIG. 14 illustrates a motorcycle with a windshield made with photochromic material that has been activated and has a tint.

FIG. 15 illustrates an automobile with a back window and sunroof made with photochromic material that in the absence of UV light is clear and lacks tinting.

FIG. 16 illustrates an automobile with a back window and sunroof made with photochromic material that has been activated and has a tint.

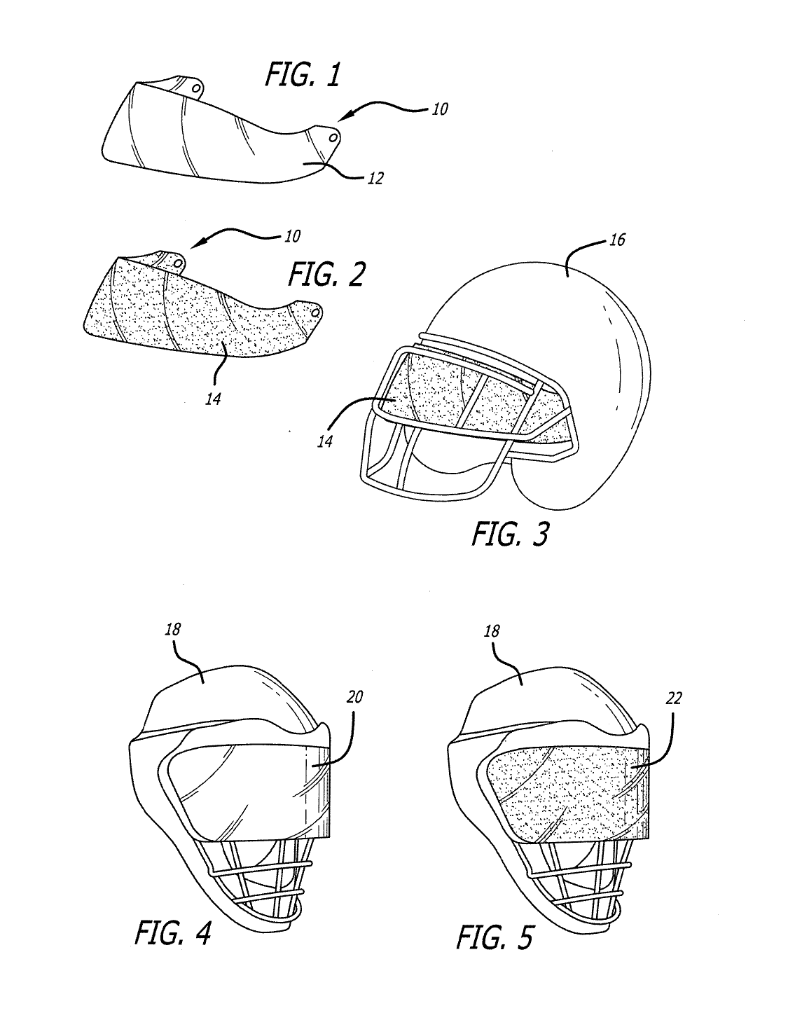

### DETAILED DESCRIPTION OF THE INVENTION

The present invention provides for use of photochromic materials for everyday activities that are affected by glare or bright sunlight. The use of photochromic materials eliminates the problem posed with using conventional tinting as the tinting adjusts based on amount of sunlight. The use of photochromic materials also adds to safety of different activities. For example, a football player will not be distracted by the sunlight, and in the event of an injury, his eyes can be examined by blocking UV light reaching the visor, so the visor automatically becomes clear.

In one embodiment, a helmet that is used to protect the head against impact where the helmet has a visor (10, 20, 22, 26, 28) that is photochromic. The helmet comprises a shell (16, 18, 24) and an open space for the eyes to see through where a photochromic visor is placed.

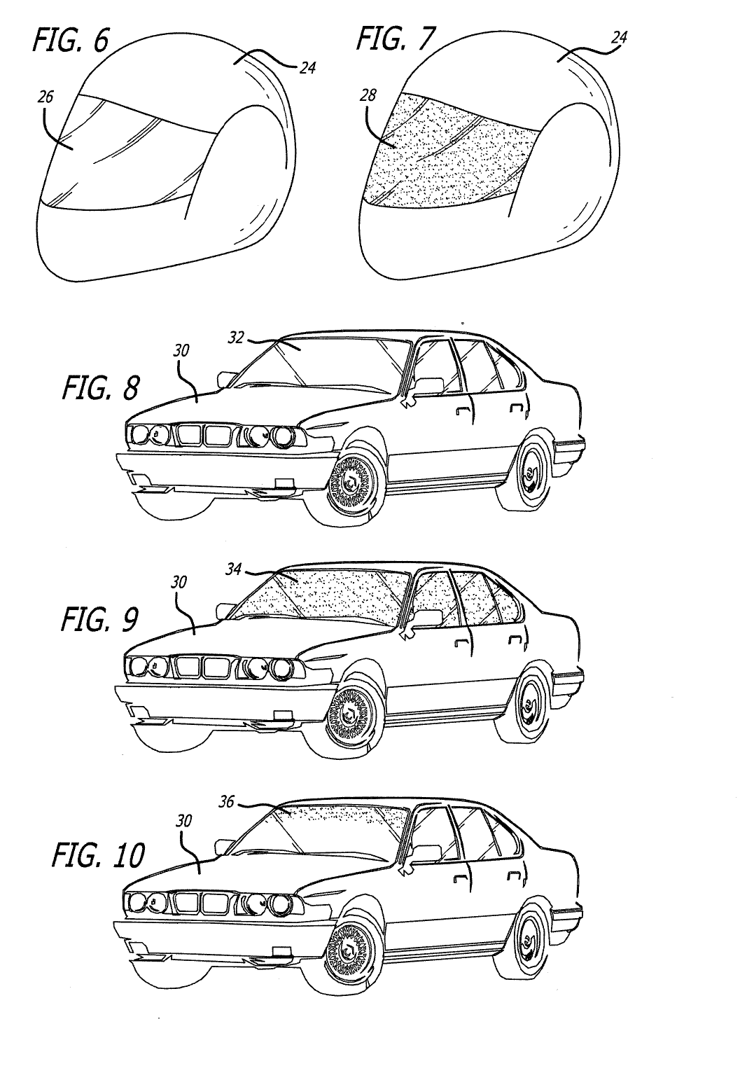

The opening can vary depending on the shape of the helmet shell. The opening is in front of the eyes so a person wearing the helmet can see through the opening. Examples of such openings include a football helmet that covers the sides and back of head, but is open in the front (where facemask is attached (FIG. 3)). Another example is a motorcycle helmet (FIGS. 6 and 7) where the shell (24) extends and covers the front of the mouth, but leaves an opening between the top of the forehead and the mouth for the eyes to see through (where visor 28 is placed).

A visor (10, 20, 22, 26, 28) allows for adjusting the amount of light a user receives when a user looks through the visor. The visor is made of a photochromic material that becomes darker in presence of UV light, and optionally provides UVA and UVB protection, and is placed in the open space of the helmet shell so a user sees through the visor. The visor for the helmet is constructed of shatterproof material, preferably polycarbonate material. The visor can have a surface having a curvature that matches that of the helmet. The visor can be a prescription lens. The visor can be permanently attached to the helmet. For example, it can be attached to a motorcycle helmet with a pivot mechanism. It can also be removably attached, such as with a pivot mechanism. Or it can be designed to slide behind the facemask of a football helmet, with a lower portion having a hook that connects to the middle of the facemask (horizontal structure) and an upper portion with long arms that slide in between the helmet shell and the top structure of the facemask.

The visor can cover at least about 30% of the open space, or at least about 50% of the open space or about 100%. The visor is preferably from about 4 inches to about 10 inches long at the maximum length and about 2 inches to about 6 inches wide at the maximum width. The parts for attaching the visor to the helmet shell are not accounted. In one embodiment, the visor is about 6 to about 10 inches long, such as about 8 inches long. The visor can be about 3 to about 5 inches wide.

The helmet can be used for playing sports. Examples of sports include those for playing American football, baseball, and cricket.

Football helmets typically have a facemask. The facemask usually has one or more structures that are horizontal and cut the facemask in an upper and a lower portions. The upper portion is the open space in front of the eyes and the lower portion in front of the mouth. Preferably the visor covers the entire upper portion of the facemask.

In baseball (FIGS. 4 and 5), softball and cricket, the catcher typically has a helmet also with a facemask. In cricket, the player hitting the ball also has a helmet with a facemask. A photochromic visor can be placed inside or outside of the facemask.

The helmet can be a motorcycle helmet (FIGS. 6 and 7). Motorcycle helmets typically have either an entire open space in the front or an open space that is surrounded on all sides including the bottom (24). The visor (28) can be shaped appropriately depending on the shape of the motorcycle helmet.

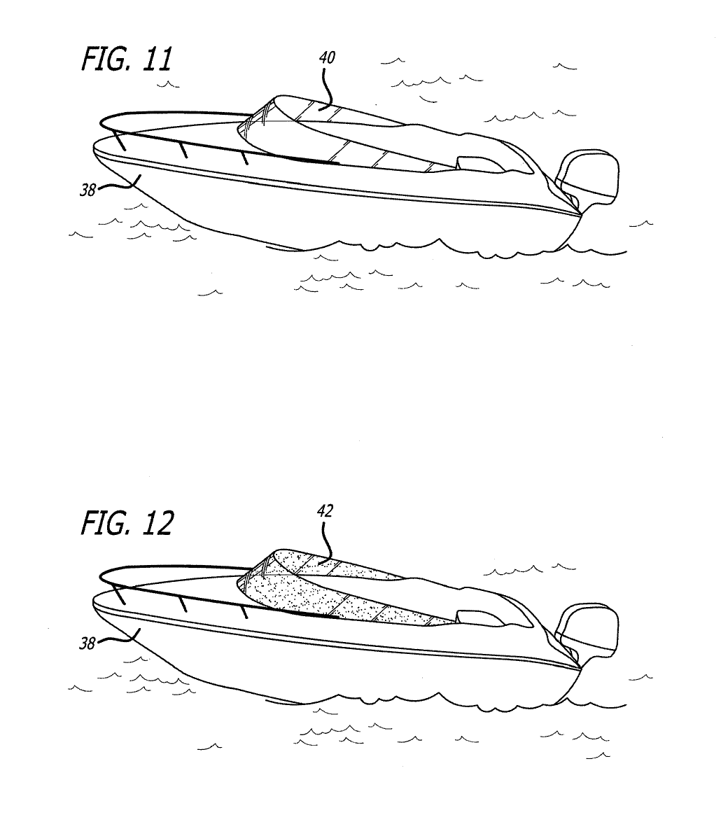

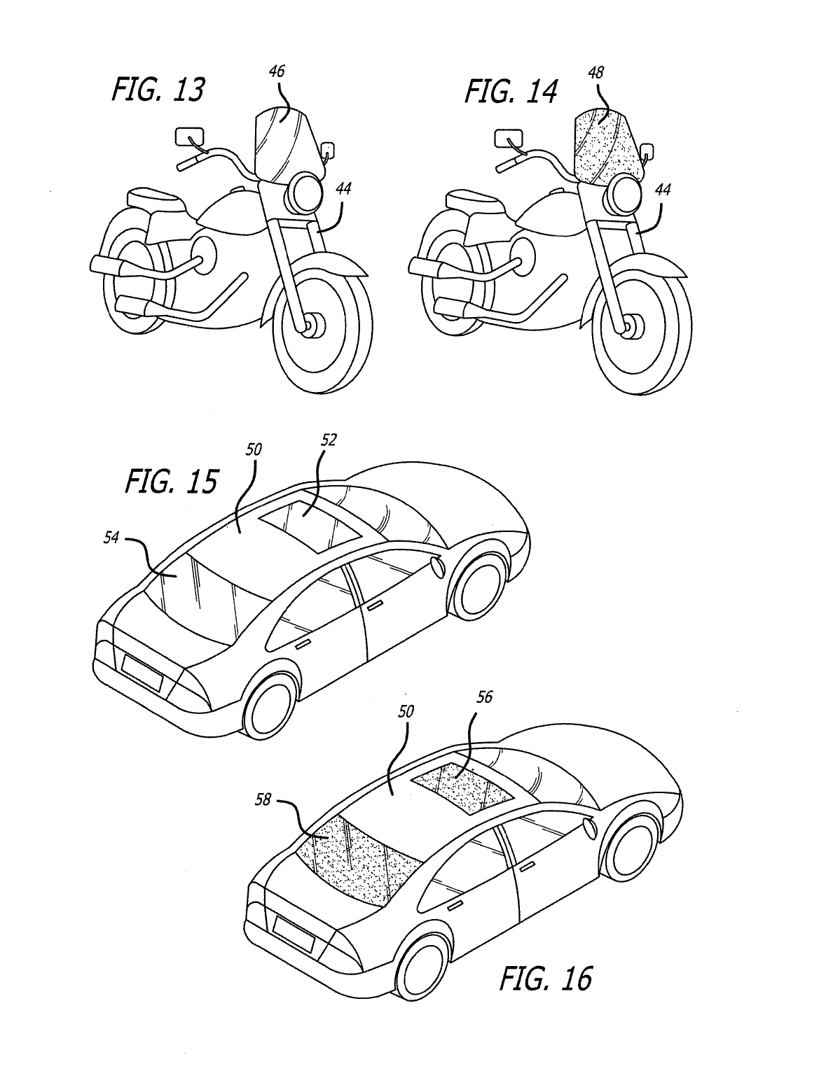

In another embodiment, the present invention provides a vehicle (FIGS. 8-16) for transportation by land, air, or water, comprising a passenger compartment and a photochromic material (32, 34, 36, 40, 46, and 48) attached to the vehicle through which a passenger (passenger is used herein to include any person in the car including the driver) sees outside of the passenger compartment, wherein the photochromic material becomes darker in presence of UV light, and optionally provides UVA and UVB protection. Examples of vehicles include automobiles (30) (including large automobiles such as trucks), boats (38), motorcycles (44), airplanes and helicopters.

Some motorcycles have a windshield (46, 48) in front. The windshield can be a substantially vertical surface for slow moving motorcycles or a highly curved small windshield for faster motorcycles. This windshield can also be made of a material that is photochromic. All (48) or only top portion of the windshield can be photochromic.

With an automobile, any of the front (34), side windows (front and back side windows) and back window (58) can be made of the photochromic material. In one embodiment, the two back windows on the sides (one on each side) and the back window are made of the photochromic material. Another part of a vehicle where a photochromic material can be used is the sunroof (56). The use of this material in the sunroof can help keep the car cool when it is sunny and eliminate the extra cover inside of the cars that are intended to block light through the sunroof. The length of the windshield and back window can be about 30 inches to about 60 inches, and a width of about 10 inches to about 30 inches. The side windows can have a length of about 10 inches to about 30 inches, and a height of about 10 inches to about 30 inches. The sunroof can have a length of about 10 inches to about 30 inches, and a width of about 8 inches to about 20 inches.

With a boat (38), whether small or large as a ship, one or more windows, or the windshield (42), can be made from photochromic materials. These can include only the windows on the side or rear of the boat.

In another embodiment, only the top portion (36) of a window or a windshield of a vehicle is made from photochromic materials. This top portion (36) can include the top portion of the front windshield of a car or a motorcycle. This embodiment allows drivers who prefer not to have tinting in an entire windshield to benefit from the use of this partial tinting on top of the windshield. The tinting can be about 3 inches to about 6 inches from top of the windshield or window.

Photochromic materials can be made of glass, plastic and other similar materials such as polycarbonate. The glass version can be made through the embedding of microcrystalline silver halides (usually silver chloride), or molecules in a glass substrate. Plastic photochromic lenses can be made by use of organic photochromic molecules (for example oxazines and naphthopyrans). The thickness, particularly for glass, or thickness of embedded material, can be adjusted to obtain the proper degree of tinting. With plastics, the photochromic dye is typically embedded into the surface layer of the plastic in a uniform thickness of up to 150 μm. The process can include dissolving the dye in a solvent, immersing and removing the surface to be made photochromic in the dye bath for dispersion of the photochromic dye over said surface, and heat treating to cause the deposited dye to firmly adhere to the lens.

The material used can also have a permanent pre-tint that is not that dark relatively. With use of a photochromic dye, the material goes from a dark to a darker state. The material can also have polarizing properties.

The photochromic material can be made so that it provides both UVA and UVB protection. Preferably more than 50% protection is provided, and in one embodiment about 100% of the provides UVA and UVB rays are blocked.

U.S. Pat. Nos. 5,975,696 and 7,035,010 are incorporated herein by reference in their entirety for teaching of different polychromic materials and processes for their preparation, and for making polarizing material.

While the invention has been particularly shown and described with reference to specific embodiments, it will be understood by those skilled in the art that changes in the form and details of the embodiments may be made without departing from the spirit or scope of the invention.

What is claimed is:

1. A helmet for protecting head against impact comprising:
a) a helmet shell with an open space for eyes to see through;
b) a shatterproof photo-chromic visor that becomes darker in presence of UV light;
wherein the visor is placed in the open space of the helmet shell so a user wearing the helmet sees through the visor.

2. The helmet of claim 1, wherein the visor is constructed of shatterproof polycarbonate material.

3. The helmet of claim 1, wherein the visor provides UVA and UVB protection.

4. The helmet of claim 1, wherein the visor surface has a curvature that matches that of the helmet.

5. The helmet of claim 1, wherein the helmet is for playing sports.

6. The helmet of claim 1, wherein the helmet is a football helmet that further comprises a facemask

7. The helmet of claim 6, wherein the football helmet has a face mask with one or more substantially horizontal structures cutting the facemask in an upper and a lower portion, with the upper portion covering the front of the eyes, wherein the visor covers at least the entire space in the upper portion.

8. The helmet of claim 1, wherein the helmet is a baseball, softball or a cricket helmet that further comprises a facemask.

9. The helmet of claim 1, wherein the helmet is a motorcycle helmet.

10. The helmet of claim 1, wherein the visor is a prescription lens.

11. The helmet of claim 1, wherein the visor is removably attached to the helmet.

12. The helmet of claim 1, wherein the visor is about 4 inches to about 10 inches long at the maximum length and about 2 inches to about 6 inches wide at the maximum width.

13. A vehicle for transportation by land, air, or water, comprising:
a) a passenger compartment; and
b) a photochromic material attached to the vehicle through which a passenger sees outside of the passenger compartment, wherein the photochromic material becomes darker in presence of UV light.

14. The vehicle of claim 13, wherein the vehicle is a motorcycle and the material is placed in front of the watert to shield a driver from wind.

15. The vehicle of claim 13, wherein the vehicle is an automobile and at least a portion of one or more of the windshield, side windows, and back window is made of the photochromic material.

16. The vehicle of claim 13, wherein the vehicle is an automobile and the two back windows on the side and the back window are made of the photochromic material.

17. The vehicle of claim 13, wherein the vehicle is an automobile and only top portion of the front or back windshield is made of photochromic material.

18. The vehicle of claim 13, wherein the vehicle is boat and at least a portion of windshield or a window is made of a photochromic material.

19. An automobile comprising a passenger compartment with a sunroof, wherein the sunroof is made of a photochromic material.
